(19) United States
(12) Patent Application Publication
(10) Pub. No.: US 2022/0373118 A1
(43) Pub. Date: Nov. 24, 2022

(54) CONNECTOR ENGAGEMENT SYSTEM

(71) Applicant: Kinetic Pressure Control Ltd., Houston, TX (US)

(72) Inventor: Steven Angstmann, Houston, TX (US)

(73) Assignee: Kinetic Pressure Control Ltd., Houston, TX (US)

(21) Appl. No.: 17/773,603

(22) PCT Filed: Oct. 29, 2020
(86) PCT No.: PCT/US20/57915

§ 371 Date: Apr. 30, 2022

Related U.S. Application Data
(60) Provisional application No. 62/931,645, filed on Nov. 6, 2019.

(51) Int. Cl. F16L 37/12; F16L 37/62; E21B 33/038

(52) U.S. Cl. CPC F16L 37/122; F16L 37/62; E21B 33/038

(57) ABSTRACT

A connector may comprise a plurality of locking members arranged to engage and disengage a well tool. Each locking member may be selectively and individually actuated to engage and/or disengage the well tool while the connector is coupled to the well tool. The position of the individual locking members may be selectively determined. The position of the locking members may be viewed on a display for remote member actuation.

Continuation of International Application No. PCT/US2020/057915 filed on Oct. 29, 2020. Priority is claimed from U.S. Provisional Application No. 62/931,645 filed on Nov. 6, 2019. Both foregoing applications are incorporated herein by reference in their entirety.

### BACKGROUND

This disclosure relates to the field of connectors. More specifically, the disclosure relates to apparatus for making connections with well tools.

In subsurface well construction, once a wellbore is drilled and the well is provided with a protective pipe (the wellbore is “cased”), a wellhead is installed to provide a structural interface between the casing in the wellbore and the surface equipment. A blowout preventer (BOP) is typically joined to the wellhead to provide well pressure control. BOPs and other equipment that may be coupled to the wellhead are typically joined to the wellhead housing with a wellhead connector. Wellhead housings are generally cylindrical in shape and have a groove profile at the upper end on their outer surface. The groove profiles typically comprise a series of grooves or ribs which provide a wellhead connector with a means for gripping the wellhead housing.

FIG. 1 shows a sectional view of a conventional wellhead connector 11 coupled to a wellhead housing as described in U.S. Pat. No. 6,070,669 issued to Radi et al. A wellhead connector 11 includes a plurality of locking members 48, one of which is shown in FIG. 1, each comprising a plurality of dogs 49. Each dog 49 has a generally rectangular cross-sectional shape and a plurality of grooves or teeth 51 on its inner surface. A cylinder 53 for a piston is located within housing 19. The cylinder 53 contains a piston 55 and is supplied with hydraulic fluid for stroking the piston 55 up and down. The piston 55 is secured to a cam ring 57 by means of its shaft 59. The cam ring 57 has an inner diameter that engages the outer surfaces of dogs 49. A stop plate 61 is mounted to an inner wall 23 radially outward of shoulders 27. The stop plate 61 limits the downward travel of the cam ring 57. Bolts 63 secure the stop plate 61 releasably to enter the inner wall 23.

In FIG. 1, the wellhead connector 11 is shown mounted over an installed wellhead housing 65. The inner diameter of a lower insert 35 snugly fits over the outer diameter of the wellhead housing 65 at the point of engagement. The inner diameter of an upper insert 41, which is smaller than the inner diameter of the lower insert 35, snugly fits over the outer diameter of wellhead housing 65 at the point of engagement. Optionally, seals 44 and 38 will sealingly engage the outer diameter of the wellhead housing 65. After the wellhead connector 11 is mounted on the wellhead housing 65, hydraulic fluid pressure is applied to the cylinder 53 to stroke the piston 55 downward. The cam ring 57 pushes the dogs 49 radially into engagement with the wellhead housing grooves 67. A large downward preload force is applied to the rim of the wellhead housing 65 as a result of the teeth 51 on the dogs 49 engaging the grooves 67. The stop plate 61 limits the downward travel of the cam ring 57. The wellhead connector 11 is thus engaged to the wellhead housing 65. To disengage the wellhead connector 11, hydraulic fluid pressure is applied to stroke the piston 55 upward, providing the dogs 49 with clearance to disengage the teeth 51 from the grooves 67 to free the wellhead housing 65.

When the wellhead connector 11 is hydraulically activated to engage with, or disengage from, the wellhead housing 65, all the locking members 48 are simultaneously activated. There is no way of verifying whether each locking member 48 has properly engaged or disengaged when activated, which may cause significant problems. For example, in subsea applications it may be necessary to perform an emergency disconnect from the wellhead housing 65, and if one or more locking members 48 fails to disengage the result may be catastrophic. Thus, a need remains for improved connector engagement techniques.

### SUMMARY

One aspect of the present disclosure is a connector which may comprise a plurality of locking members configured to engage and disengage a well tool. Each locking member is configured for selective individual activation while the connector is coupled to the well tool.

In some embodiments, the locking members each comprise a position indicator.

In some embodiments, the locking members comprise a piston disposed within a cylinder.

In some embodiments, the position indicator comprises a switch operable by an element linked to the piston.

In some embodiments, the locking member position indicator comprises a linear variable differential transformer.

Some embodiments further comprise an electronics module in signal communication with each position indicator.

In some embodiments, each locking member is operable by hydraulic fluid and the connector further comprises control valves operable to apply hydraulic fluid to activate each locking member.

In some embodiments, the well tool comprises one of a well tubular or wellhead housing.

In some embodiments, the locking members are configured for remote activation.

In some embodiments each piston is operable to displace a cam ring coupled thereto, and the cam ring has a shoulder shaped to apply lateral force to a locking element.

In some embodiments, the locking element comprises a dog having teeth on one end.

In some embodiments, the connector is configured for signal communication with a display for remote viewing of an indication of the position of the locking members.

In some embodiments, the connector is configured for underwater operation.

A method for operating a connector according to another aspect of the disclosure includes operating a plurality of locking members in the connector each configured to engage and disengage a well tool. Each locking member is selectively activated to engage or disengage the well tool while the connector is coupled to the well tool.

In some embodiments, the position of each locking member is selectively determined.

In some embodiments, determining the position of the locking member comprises determining the position of a piston within a cylinder of each locking member.

In some embodiments, the position of the locking member is determined using a linear variable differential transformer.

In some embodiments, operating the locking members comprises applying hydraulic pressure to the member.

In some embodiments, the locking members are operated from a location remote from the connector.

In some embodiments, the locking members are operated while the connector is coupled to the well tool under water.

In some embodiments, the well tool comprises one of a well tubular or wellhead housing.

In some embodiments, the connector is in signal communication with a display for remote viewing of an indication of the position of the locking members.

Other aspects and possible advantages will be apparent from the following description and claims.

### BRIEF DESCRIPTION OF THE DRAWINGS

FIG. 1 shows a sectional view of a conventional wellhead connector coupled to a wellhead housing.

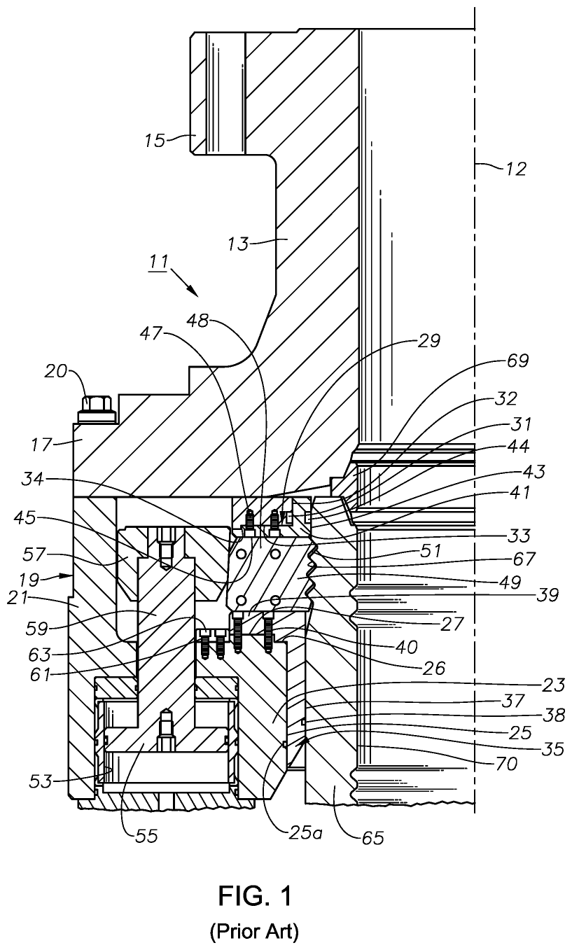

FIG. 2 shows a sectioned view of an example embodiment of a connector 30 according to this disclosure.

FIG. 3 shows an expanded view of the embodiment of FIG. 2.

FIG. 4 shows a plan view of an embodiment of a connector.

FIG. 5 shows an example embodiment of a control system for a connector according to the present disclosure.

FIG. 6 shows a subsea well having a connector according to the present disclosure.

### DETAILED DESCRIPTION

Illustrative embodiments are disclosed herein. In the interest of clarity, not all features of an actual implementation are described. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The disclosed embodiments are not to be limited to the precise arrangements and configurations shown in the figures, in which like reference numerals may identify like elements. Also, the figures are not necessarily drawn to scale, and certain features may be shown exaggerated in scale or in generalized or schematic form, in the interest of clarity and conciseness.

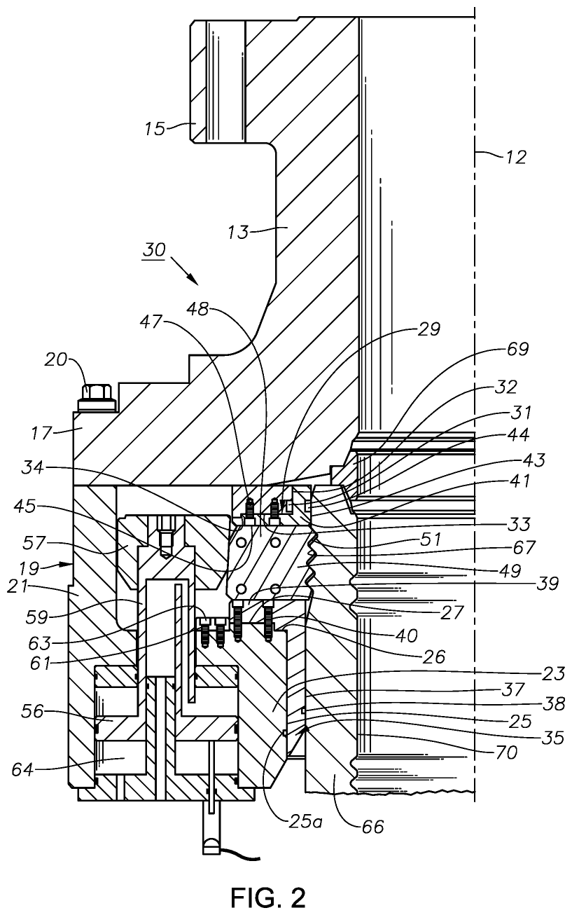

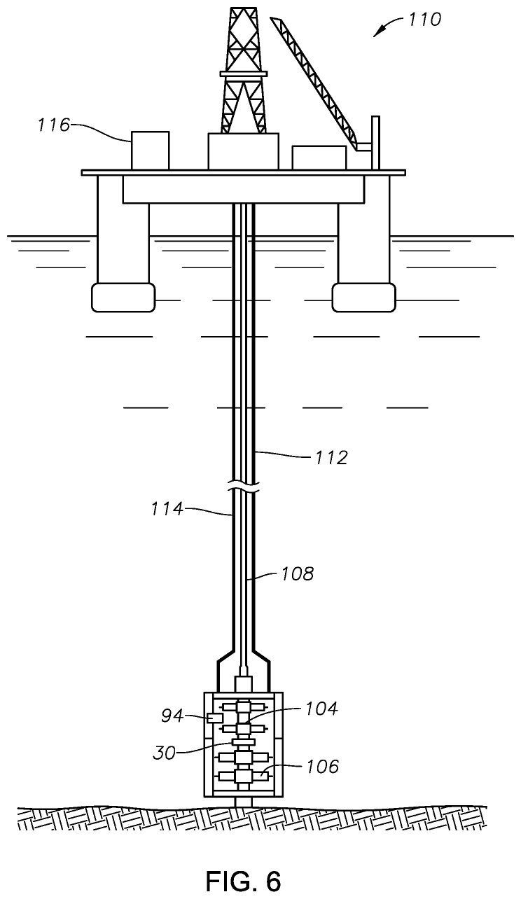

FIG. 2 shows a sectioned view of an example embodiment of a connector 30 according to this disclosure. To some extent, the connector 30 embodiments of this disclosure may be generally configured with a structure resembling the devices described in U.S. Pat. No. 6,070,669 issued to Radi et al., however, such configuration is not a limit on the scope of the present disclosure. A connector 30 embodiment may include a tubular adapter 13 having an upper flange 15 that can be coupled to a tubular or tool (see FIG. 6). The adapter 13 may comprise a lower flange 17 extending radially outward from a longitudinal axis 12 of the connector 30. A connector housing 19, which may be cylindrically shaped, may be bolted to one side of lower flange 17, e.g., using bolts 20. The connector housing 19 has an outer wall 21 that extends downward from the lower flange 17. The connector housing 19 has an inner wall 23 that may be concentric with and radially inward from the outer wall 21. The inner wall 23 has an inner diameter 25 that is cylindrical and may contain a seal 25a. A window or annular space 29 may be located above the upper end of the inner wall 23. The window 29 comprises a lower shoulder 27 which is perpendicular to the longitudinal axis 12 and which extends radially outward from the inner diameter 25. A shear resisting shoulder 26 may be formed at the junction between inner diameter 25 and the lower shoulder 27. An upper shoulder 33 is located on the lower end of the adapter 13, forming an upper edge of the window 29. The upper shoulder 33 may extend radially outward from a cylindrical upper inner wall 32 parallel to and spaced above the lower shoulder 27. A shear resisting shoulder 34 may be formed in the upper shoulder 33. The inner diameter of the upper inner wall 32 may be slightly smaller than the connector housing inner diameter 25.

A seal 31 may be located in the upper inner wall 32. A lower insert 35 may be mounted to the connector housing inner wall 23. The lower insert 35 may generally have a cross-sectional shape of an inverted “L” having a cylindrical portion 37 extending downward and a flange 39 on the upper end extending radially outward into the window 29. The flange 39 overlies the shoulder 27, and the cylindrical portion 37 is closely received within the inner diameter 25. Bolts 40 extend through the flange 39 for securing the lower insert 35 in place. A seal 38 is optionally located in the inner diameter of the lower insert 35.

An upper insert 41 is mounted to the upper shoulder 33. The upper insert 41 may have a cylindrical portion 43 that mates with the inner diameter of the upper inner shoulder 32. The upper insert 41 may have a seal 44 on its inner diameter. A flange 45 extends radially outward through the window 29 and overlies the shoulder 33. Bolts 47 may extend into the shoulder 33 to secure the upper insert 41 in place. The inserts 35, 41 may decrease the axial height of the window 29. The connector 30 includes a plurality of locking members 48, with each locking member comprising a dog 49. Each dog 49 locates within the window 29 and has a plurality of grooves or teeth 51 on its inner surface. The dogs 49 may have a generally rectangular cross-sectional shape.

A cylinder 64 is located within the connector housing 19. The cylinder 64 contains a piston 56 and is supplied with hydraulic fluid for stroking the piston 56 up and down (described below). The piston 56 may be secured to a cam ring 57 by means of its shaft 59. The cam ring 57 has an inner diameter that engages the outer surface of the dogs 49. A stop plate 61 is mounted to the inner wall 23 radially outward of the shoulders 27. The stop plate 61 limits the downward travel of the cam ring 57. Bolts 63 may secure the stop plate 61 releasably so as to enter the inner wall 23. FIG. 2 shows the connector 30 with the piston 56 in the locked position. In the locked position, the teeth 51 of the dogs 49 are engaged with grooves 67 on the exterior of a well tool 66 (e.g., a tubular, wellhead housing, BOP stack, oil well Christmas tree, etc.). A seal 69 seals the bore 70 of the tubular 66 to the adapter 13.

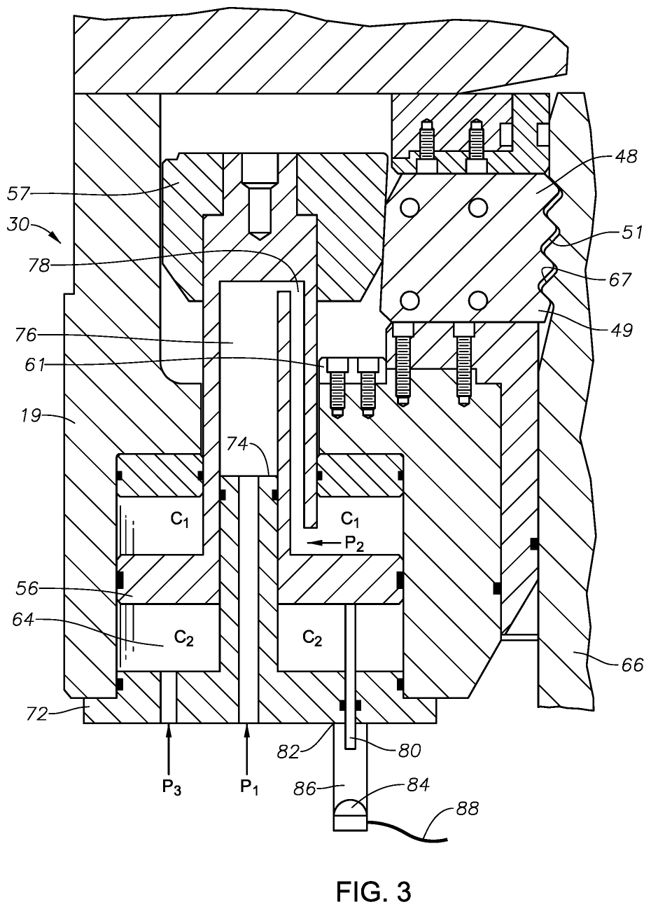

FIG. 3 shows an expanded view of the embodiment of FIG. 2. In the present embodiment, a ported end cap 72 may be mounted on the connector housing 19 to sealingly cover the piston cylinder 64. The end cap 72 has a first orifice P1 leading into a central stem 74, extending into cylinder 64 and into a primary port 76 formed in the piston 56 body. The primary port 76 leads into a secondary port 78 also formed in the piston 56 body. The secondary port 78 terminates at a second orifice P2 that leads to a first cavity C1 formed in the cylinder 64 adjacent to the inner side of the piston 56 head. The end cap 72 has a third orifice P3 leading to a second cavity C2 formed in the cylinder 64 adjacent the outer side of the piston 56 head.

In operation, when locking engagement of the connector 30 to a tubular 66 is desired, hydraulic fluid pressure is applied to the first orifice P1 to flow through primary ports 76 and secondary ports 78, out through the second orifice P2, and into the cavity C1 so as to stroke the piston 56 downward. The cam ring 57 then pushes the dogs 49 radially into engagement with the grooves 67 on the exterior of the tubular 66. The stop plate 61 limits the downward travel of the cam ring 57. The connector 30 is thus engaged. To disengage the connector 30, hydraulic fluid pressure is applied to the third orifice P3 to fill the cavity C2 and stroke the piston 56 upward, providing the dogs 49 with the necessary clearance to disengage the teeth 51 from the grooves 67 to free the tubular 66.

As shown in FIG. 3, some embodiments of the connector 30 may also be implemented with a position indicator responsive to the position of the piston 56 within the cylinder 64. In the present example embodiment, the position indicator may comprise an elongated pin 80 affixed to one side of the piston head. The pin 80 runs through and extends out of a hole 82 in the end cap. 72 A switch, for example, a microswitch 84 may affixed on the end cap 72, positioned in alignment with the pin 80 inside a waterproof enclosure 86. The waterproof enclosure 86 holds the microswitch 84 at a fixed distance from the pin 80, such that when the piston 56 is stroked downward to engage the dogs 49, the end of the pin 80 depresses the microswitch 84. Depressing the microswitch 84 may either open or close the microswitch 84, to provider an electric confirmation signal, i.e., switch closed or open, to the microswitch lead 88. When the piston 56 is stroked upward to disengage the dog 49, the end of the pin 84 releases from the microswitch 84, changing the switch condition and thereby terminating the electric confirmation signal via the lead 88. It will be appreciated by those skilled in the art that conventional seals may be used to implement the connector 30 embodiments of this disclosure. Further, the present embodiment is only one example of a position indicator. Some embodiments may comprise, for example and without limitation, a linear position indicator such as a linear variable differential transformer (LVDT—not shown) disposed about the pin 80. In such embodiments, the pin 80 may comprise a ferromagnetic material such as ferrite, such that the linear position of the pin 80 may be detected and a corresponding signal generated by the LVDT.

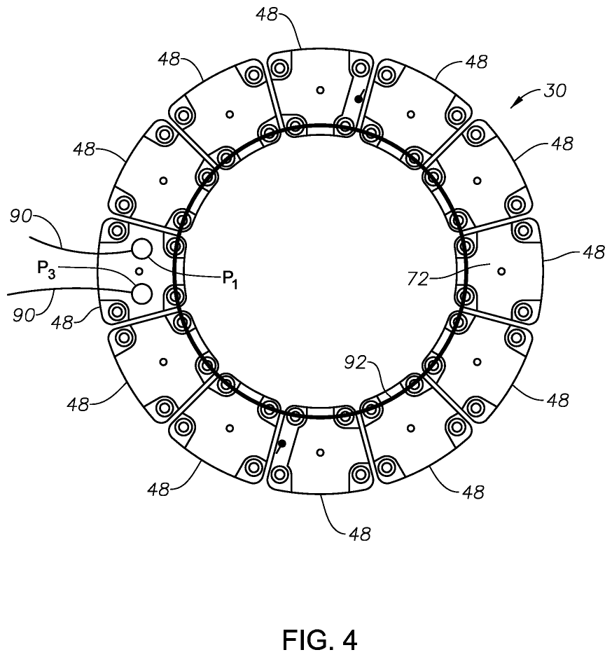

FIG. 4 shows a plan view from the bottom of an example embodiment of a connector 30 according to this disclosure. The connector 30 may be configured with a plurality of locking members 48, which may be configured as explained with reference to FIGS. 2 and 3, arranged in a donut-shaped structure. In this embodiment, the connector 30 may comprise 12 locking members 48, each with its own end cap 72. Each end cap 72 may be configured with a pair of hydraulic fluid lines 90 respectively coupled to the first and third orifices P1, P3 (as explained with reference to FIG. 3) to provide fluid under pressure to stroke the respective piston (56 in FIG. 3) of each locking cylinder 48 as described herein. Only one pair of hydraulic fluid lines 90 are shown in FIG. 4 for clarity of the illustration. The microswitch leads 88 (see FIG. 3) from each locking member cylinder 48 may be connected in a wiring harness (not shown). Connections within the wiring harness may comprise all microswitches (84 in FIG. 3) to be connected whereby an “all closed” signal may be generated when all the locking members 48 are fully engaged, and an “all open” signal when all the locking members 48 are disengaged. In some embodiments, the individual switch condition may be detected and such individual switch conditions used to determine the engagement or disengagement state of each locking member 48.

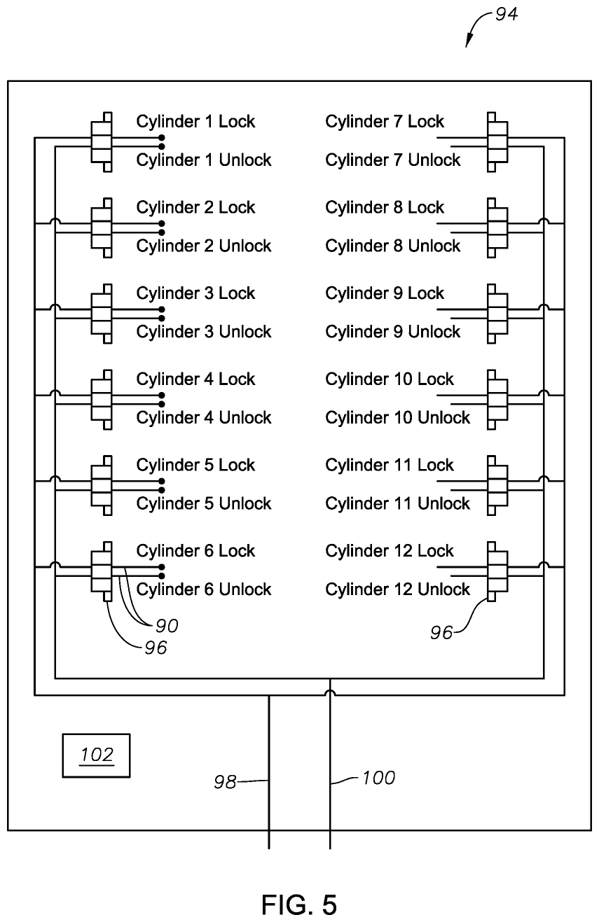

FIG. 5 show a schematic diagram of a control module 94 that may be implemented with embodiments of a connector according to this disclosure. The control module 94 may comprise a plurality of hydraulic valves 96 (one for each locking member 48 cylinder on the connector 30). The hydraulic valves may be electrically operated, e.g., by a solenoid or other actuator. The control module 94 may be coupled to a hydraulic fluid supply line 98 and a hydraulic fluid vent/return line 100. When activated, each hydraulic valve 96 conducts hydraulic fluid to/from the first and third orifices P1, P3 on the respective locking member 48. In this manner, each locking member cylinder 48 can be independently activated to engage or disengage as desired, or all locking member cylinders 48 can be activated to simultaneously engage or disengage. Unlike conventional connectors that are limited to simultaneous operation of all locking elements at once, embodiments of this disclosure enable selective activation of the individual locking members 48 to engage or disengage the member from the well tool 66 as desired. Another advantage provided by embodiments of the present disclosure is the ability to perform the selective activation and/or position determination of the locking members 48 while the connector 30 is coupled to the well tool 66. The control module 94 may also be configured with an electronic controller 102 (e.g., a microcomputer, microprocessor or programmable logic controller) to power/control the hydraulic valves 96 when electrically operated valves are used. Some embodiments may be implemented with the electronics module 102 positioned at a distance from the control module 94 and linked to one another via a physical signal line or wirelessly as known in the art. Signals from each of the position sensors (e.g., switch 84 in FIG. 3) may be interrogated by the electronics module 102 when each locking member 48 is actuated so that actuation status may of each locking member 48 may be determined with reference to the function commanded by the electronics module 102 (i.e., lock or unlock) for each locking member 48.

FIG. 6 shows an example embodiment of a connector 30 according to this disclosure used for coupling an upper BOP stack assembly 104 to a lower BOP stack assembly 106 on an offshore well. The upper BOP stack assembly 104 may be coupled to a riser 108 extending from a floating platform 110. As known in the art, BOPs are typically configured with a hydraulic fluid supply, either on the BOP stack itself and/or from a hydraulic line 112 extending from the floating platform 110. A multiplex (MUX) cable 114 provides a power/signal communication line between the BOP (in FIG. 6 comprised of the upper 104 and lower 106 BOP stacked) and the floating platform 110 as known in the art. In this embodiment, the control module 94 may be mounted on the BOP and coupled into the BOP hydraulic fluid supply to provide the locking member cylinders (48 in FIG. 4) cylinders with hydraulic fluid to operate as described herein with reference to FIGS. 2 and 3. It will be appreciated that embodiments of a connector 30 according to this disclosure may also be implemented with the connector having its own independent pressurized hydraulic fluid supply (not shown) for operation. The electronics module (102 in FIG. 5) on the control module 94 and the connector 30 wiring harness (not shown), bundling the microswitch leads 88 (see FIG. 3)) may be linked to the MUX cable 114 to allow an operator on the floating platform 110 to remotely control operation of the locking member cylinders (48 in FIG. 4) and to receive the microswitch 84 confirmation signals for viewing on a display 116 (e.g. computer display, smartphone, tablet, etc.). With such embodiments, an operator can engage, disengage, or test cycle the locking member cylinders (48 in FIG. 4) on the connector 30 independently or simultaneously, receiving a confirmation signal associated with each locking member cylinder (48 in FIG. 4).

It will be appreciated that embodiments of the disclosed connectors 30 may be implemented for use in numerous applications and operations, in the oil and gas industry and in other fields of endeavor. It will also be appreciated by those skilled in the art that embodiments of this disclosure may be implemented with conventional software applications, electronics, and hardware components (e.g. conventional seals, valves, switches, solenoids, etc.). Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A connector, comprising:
a plurality of locking members configured to engage and disengage a well tool,
wherein each locking member is configured for selective individual activation while the connector is coupled to the well tool.

2. The connector of claim 1 wherein each locking member comprises a position indicator.

3. The connector of claim 2 wherein each locking member comprises a piston disposed within a cylinder.

4. The connector of claim 1 further comprising an electronics module in signal communication with the locking members.

5. The connector of claim 1 wherein each locking member is operable by hydraulic fluid, the connector further comprising control valves operable to apply hydraulic fluid to activate each locking member.

6. The connector of claim 1 wherein the well tool comprises one of a well tubular or wellhead housing.

7. The connector of claim 1 wherein the locking members are configured for remote activation.

8. The connector of claim 1 wherein the connector is configured for signal communication with a display for remote viewing of an indication of the position of the locking members.

9. The connector of claim 1 wherein the connector is configured for underwater operation.

10. A method for operating a connector, comprising:
operating a plurality of locking members in the connector, each member configured to engage and disengage a well tool,
wherein each locking member is selectively activated to engage or disengage the well tool while the connector is coupled to the well tool.

11. The method of claim 10 further comprising selectively determining the position of each locking member.

12. The method of claim 10 wherein operating the locking members comprises applying hydraulic pressure to the members.

13. The method of claim 10 wherein the locking members are operated from a location remote from the connector.

14. The method of claim 10 wherein the locking members are operated while the connector is coupled to the well tool under water.

15. The method of claim 10 wherein the connector is in signal communication with a display for remote viewing of an indication of the position of the locking members.
